(19) United States
(12) Patent Application Publication
(10) Pub. No.: US 2025/0196753 A1
(43) Pub. Date: Jun. 19, 2025

(54) METHOD, SYSTEM, AND SHIPPING VEHICLE FOR SHIPPING ITEMS VIA AUTO CARRIERS

(71) Applicant: Nicholas Madore, Dartmouth (CA)

(72) Inventor: Nicholas Madore, Dartmouth (CA)

(21) Appl. No.: 18/978,091

(22) Filed: Dec. 12, 2024

(30) Foreign Application Priority Data
Dec. 19, 2023 (CA) 3223672

(51) Int. Cl. B60P 3/42

(52) U.S. Cl. CPC B60P 3/42

(57) ABSTRACT

A method, system, and shipping vehicle for shipping items via an auto carrier are provided. The shipping vehicle, with loaded items, is moved on and secured to a deck of an autorack railcar. After the railcar is then moved from a first location to a second location, the vehicle is un-secured and removed from the deck of the railcar to a location for unloading the items from the vehicle. The vehicle comprises a chassis adapted for holding the items thereon or having an enclosure mounted thereon for holding items therein. A first and second set of wheels are mounted to the chassis in proximity to a first end and second end, respectively. A first and second steering mechanism are connected to the first and second set of wheels, respectively. Securing elements are mounted at first and second ends for securing the shipping vehicle to a deck of the auto carrier.

### CROSS-REFERENCE TO RELATED APPLICATION

The present application claims the benefit of priority to Canadian patent application 3,223,672, filed Dec. 19, 2023, the contents of which are hereby incorporated by reference in their entirety.

### FIELD

The present invention relates to shipping of items, and more particularly to a method, a system, and a shipping vehicle for shipping items via auto carriers such as autorack railcars, auto carrier trucks, and flatbed tow trucks.

### BACKGROUND

Autorack railcars and auto carrier trucks are adapted for transporting automobiles and light trucks. Typically, autorack railcars are used to transport vehicles from a manufacturing facility or a port to a distribution node with railway access, while auto carrier trucks are used to transport the vehicles from the distribution node to car dealers at locations without railway access.

Present-day autorack railcars generally comprise two or three decks for transporting vehicles, with some autorack railcars being convertible between two and three decks to accommodate vehicles of different height such as, for example, compact cars, sedans, vans, and pick-up trucks, while optimizing use of the inside space of the autorack railcar. The autorack railcars typically provide a full enclosure with continuous side panels, end doors, and roofs to protect the vehicles placed therein from severe weather, theft, vandalism, or other in-transit damage.

To load an autorack railcar, a skilled driver drives the vehicle up a ramp and onto one of the decks. The driver or another crew member then secures the vehicle to the deck with, for example, tie down straps or chains. To unload the autorack railcar the same process is performed in reverse.

Present day auto carrier trucks generally include two decks for transporting vehicles and are loaded/un-loaded in a similar manner as the autorack railcar.

Presently, railway companies in North America operate approximately 300,000 autorack rail cars on approximately 170,000 miles of railway, mainly for transporting new vehicles from manufacturers or ports to distribution nodes with railway access, resulting in many autorack rail cars being moved between various locations without load. Similarly, a large number of auto carrier trucks is available for transporting the new vehicles from the distribution nodes with railway access to various dealerships at locations without railway access, which are also frequently operated without load between various locations.

Present-day freight transport via rail is geared towards bulk transportation of large quantities of goods using various types of large size rail cars such as, for example, box cars, centerbeam cars, hopper cars, flat cars, and well cars. However, numerous manufacturers produce goods in smaller batches for shipping over long distances which are too small to fill one of the large size rail cars, leaving only transport via truck which is substantially more expensive.

It is desirable to provide a method and system that enable shipping of smaller batches of items via autorack railcars between main shipping terminals having railway access.

It is also desirable to provide a method and system that enable shipping of smaller batches of items via auto carrier trucks and flatbed tow trucks between secondary shipping terminals without railway access and main shipping terminals having railway access.

It is also desirable to provide a method and system that enable easy handling of smaller batches of items for shipping via autorack railcars, auto carrier trucks, and flatbed tow trucks.

It is also desirable to provide a shipping vehicle that is adapted to fit onto a deck of autorack railcars, auto carrier trucks, and flatbed tow trucks and complies with the load requirements thereof.

It is also desirable to provide a shipping vehicle that enables easy loading of smaller batches of items, that is easily moved onto/from a deck of an autorack railcar, an auto carrier truck, or a flatbed tow truck, and that is easily secured to the deck of the autorack railcar, the auto carrier truck, or the flatbed tow truck.

It is also desirable to provide a shipping vehicle that is simple, substantially lightweight, and cost effective to manufacture.

### SUMMARY

Accordingly, one object of the present invention is to provide a method and system that enable shipping of smaller batches of items via autorack railcars between main shipping terminals having railway access.

Another object of the present invention is to provide a method and system that enable shipping of smaller batches of items via auto carrier trucks and flatbed tow trucks between secondary shipping terminals without railway access and main shipping terminals having railway access.

Another object of the present invention is to provide a method and system that enable easy handling of smaller batches of items for shipping via autorack railcars, auto carrier trucks, and flatbed tow trucks.

Another object of the present invention is to provide a shipping vehicle that is adapted to fit onto a deck of autorack railcars, auto carrier trucks, and flatbed tow trucks and complies with the load requirements thereof.

Another object of the present invention is to provide a shipping vehicle that enables easy loading of smaller batches of items, that is easily moved onto/from a deck of an autorack railcar, an auto carrier truck, or a flatbed tow truck, and that is easily secured to the deck of the autorack railcar, the auto carrier truck, or the flatbed tow truck.

Another object of the present invention is to provide a shipping vehicle that is simple, substantially lightweight, and cost effective to manufacture.

According to one aspect of the present invention, there is provided a method for shipping items via an auto carrier. The items are loaded onto or into a shipping vehicle. The shipping vehicle is then moved onto a deck of an autorack railcar and secured to the deck of the autorack railcar. The autorack railcar is then moved from a first location to a second location. After arrival at the second location, the shipping vehicle is un-secured from the deck of the autorack railcar and removed from the deck of the autorack railcar to a location for unloading the items from the shipping vehicle.

According to the one aspect of the present invention, there is provided a method for shipping items via an auto carrier. The items are loaded onto or into a shipping vehicle. The shipping vehicle is then moved onto a deck of an autorack railcar and secured to the deck of the autorack railcar. The autorack railcar is then moved from a first location to a second location. After arrival at the second location, the shipping vehicle is un-secured from the deck of the autorack railcar and removed from the deck of the autorack railcar and moved onto a deck of an auto carrier truck, or a flatbed tow truck. After the shipping vehicle is secured to the deck of the auto carrier truck, or the flatbed tow truck, the auto carrier truck, or the flatbed tow truck is moved from the second location to a third location. After arrival at the third location, the shipping vehicle is un-secured from the deck of the auto carrier truck, or the flatbed tow truck and removed from the deck of the auto carrier truck, or the flatbed tow truck to a location for unloading the items from the shipping vehicle.

According to the one aspect of the present invention, there is provided a method for shipping items via an auto carrier. The items are loaded onto or into a shipping vehicle. The shipping vehicle is then moved onto a deck of an auto carrier truck, or a flatbed tow truck and secured to the deck of the auto carrier truck, or the flatbed tow truck. The auto carrier truck, or the flatbed tow truck, is then moved from the first location to a second location. After arrival at the second location, the shipping vehicle is unsecured from the deck of the auto carrier truck, or the flatbed tow truck and removed from the deck of the auto carrier truck, or the flatbed tow truck. The shipping vehicle is then moved onto a deck of an autorack railcar and secured to the deck of the autorack railcar. The autorack railcar is then moved from the second location to a third location. After arrival at the second location, the shipping vehicle is un-secured from the deck of the autorack railcar and removed from the deck of the autorack railcar to a location for unloading the items from the shipping vehicle.

According to another aspect of the present invention, there is provided a system for shipping items via an auto carrier. The system for shipping items via an auto carrier comprises a shipping vehicle for holding the items thereon or therein. The shipping vehicle is adapted to fit onto a deck of the auto carrier and to comply with the load requirements of the auto carrier. The system further comprises means for moving the shipping vehicle onto/from a deck of the auto carrier and means for securing the shipping vehicle to the deck of the auto carrier.

According to the other aspect of the present invention, there is provided a system for shipping items via an auto carrier. The system for shipping items via an auto carrier comprises a shipping vehicle for holding the items thereon or therein. The shipping vehicle is adapted to fit onto a deck of the auto carrier such as, for example, an autorack railcar, auto carrier truck, and a flatbed tow truck and to comply with the load requirements of the auto carrier. The shipping vehicle is adapted for being pushed or pulled at a first end and a second end thereof using one of a tow tractor, a pick-up truck, or a winch. The shipping vehicle is secured to the deck of the auto carrier using chains or tie-down straps.

According to yet another aspect of the present invention, there is provided a shipping vehicle for shipping items via an auto carrier. The shipping vehicle comprises a chassis adapted for holding the items thereon or having an enclosure mounted thereon for holding the items therein. A first set of wheels is mounted to the chassis in proximity to a first end thereof and a second set of wheels is mounted to the chassis in proximity to a second end thereof. A first steering mechanism is connected to the first set of wheels and a second steering mechanism connected to the second set of wheels. Securing elements are mounted to the chassis at the first end and the second end for securing the shipping vehicle to a deck of the auto carrier. The shipping vehicle is adapted to fit onto a deck of the auto carrier and to comply with the load requirements of the auto carrier.

According to the yet another aspect of the present invention, there is provided a shipping vehicle for shipping items via an auto carrier. The shipping vehicle comprises a chassis adapted for holding the items thereon or having an enclosure mounted thereon for holding the items therein. A first set of wheels is mounted to the chassis in proximity to a first end thereof and a second set of wheels is mounted to the chassis in proximity to a second end thereof. Each of the first set of wheels and the second set of wheels comprises two casters. A first steering mechanism is connected to the first set of wheels and a second steering mechanism connected to the second set of wheels. Securing elements are mounted to the chassis at the first end and the second end for securing the shipping vehicle to a deck of the auto carrier. The shipping vehicle is adapted to fit onto a deck of the auto carrier and to comply with the load requirements of the auto carrier. The shipping vehicle comprises a first drawbar at a first end and a second drawbar at a second end thereof, the first drawbar and the second drawbar being pivotally movable between a substantially horizontal position and a substantially vertical position. The shipping vehicle further comprises a first and a second steering limiting mechanism for limiting a steering range of the first set of wheels and the second set of wheels, respectively.

According to the yet another aspect of the present invention, there is provided a shipping vehicle for shipping items via an auto carrier. The shipping vehicle comprises a chassis adapted for holding the items thereon or having an enclosure mounted thereon for holding the items therein. A first set of wheels is mounted to the chassis in proximity to a first end thereof and a second set of wheels is mounted to the chassis in proximity to a second end thereof. Each of the first set of wheels and the second set of wheels comprises two casters. A first steering mechanism is connected to the first set of wheels and a second steering mechanism connected to the second set of wheels. Securing elements are mounted to the chassis at the first end and the second end for securing the shipping vehicle to a deck of the auto carrier. The shipping vehicle is adapted to fit onto a deck of the auto carrier and to comply with the load requirements of the auto carrier. The shipping vehicle comprises a first drawbar at a first end and a second drawbar at a second end thereof, the first drawbar and the second drawbar being pivotally movable between a substantially horizontal position and a substantially vertical position. The shipping vehicle further comprises a first and a second steering locking mechanism for locking the first set of wheels and the second set of wheels, respectively, in a substantially straight direction when engaged.

An advantage of the present invention is that it provides a method and system that enable shipping of smaller batches of items via autorack railcars between main shipping terminals having railway access.

A further advantage of the present invention is that it provides a method and system that enable shipping of smaller batches of items via auto carrier trucks and flatbed tow trucks between secondary shipping terminals without railway access and main shipping terminals having railway access.

A further advantage of the present invention is that it provides a method and system that enable easy handling of smaller batches of items for shipping via autorack railcars, auto carrier trucks, and flatbed tow trucks.

A further advantage of the present invention is that it provides a shipping vehicle that is adapted to fit onto a deck of autorack railcars, auto carrier trucks, and flatbed tow trucks and complies with the load requirements thereof.

A further advantage of the present invention is that it provides a shipping vehicle that enables easy loading of smaller batches of items, that is easily moved onto/from a deck of an autorack railcar, an auto carrier truck, or a flatbed tow truck, and that is easily secured to the deck of the autorack railcar, the auto carrier truck, or the flatbed tow truck.

A further advantage of the present invention is that it provides a shipping vehicle that is simple, substantially lightweight, and cost effective to manufacture.

### BRIEF DESCRIPTION OF THE DRAWINGS

A preferred embodiment of the present invention is described below with reference to the accompanying drawings, in which:

FIG. 1 is a simplified block diagram illustrating a system for shipping smaller batches of items via auto carriers according to a preferred embodiment of the invention;

FIGS. 2 to 4 are simplified block diagrams illustrating in side views loading of shipping vehicles onto a deck of an auto carrier of the system for shipping smaller batches of items via auto carriers according to the preferred embodiment of the invention;

FIGS. 5 to 7 are simplified block diagrams illustrating in cross sectional views an auto carrier with shipping vehicles of the system for shipping smaller batches of items via auto carriers according to the preferred embodiment of the invention; and,

FIGS. 8 to 12 are simplified block diagrams illustrating in a side view, a front view, a rear view, a bottom view, and a perspective top view, respectively, a shipping vehicle according to a preferred embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is focused on shipping of small batches of items via autorack railcars, it will become evident to those skilled in the art that the embodiments of the invention are not limited thereto, but are also adaptable for shipping small batches of items via other auto carriers such as, for example, auto carrier trucks and flatbed tow trucks.

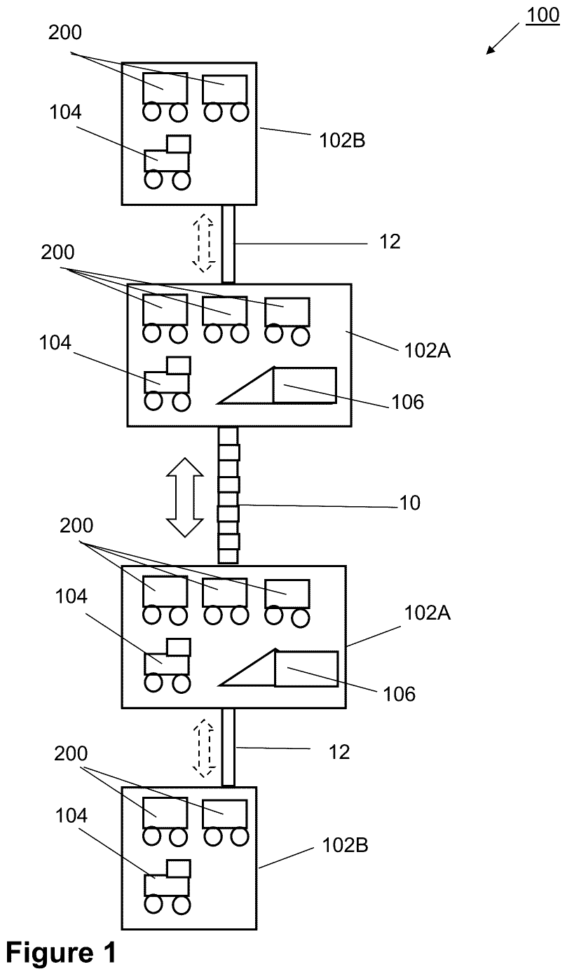

Referring to FIGS. 1 to 6, a system 100 for shipping smaller batches of items via auto carriers according to a preferred embodiment of the invention is provided. The system 100 comprises a plurality of main shipping terminals 102A that have railway access 10 and, therefore, enable shipping of the smaller batches of items therebetween via autorack railcars 20, as indicated by the solid block arrow in FIG. 1. Preferably, the system 100 further comprises a plurality of secondary shipping terminals 102B at locations without railway access 10 but with road access 12 that enable shipping of the smaller batches of items via auto carrier trucks or flatbed tow trucks between the secondary shipping terminals 102B and the main shipping terminals 102A, as indicated by the dashed block arrows in FIG. 1. It is noted that only two main shipping terminals 102A and two secondary shipping terminals 102B are illustrated in FIG. 1 for simplicity, but the system 100 is not limited thereto and may comprise any number of main shipping terminals 102A and secondary shipping terminals 102B distributed over, for example, a selected region or countrywide.

The system 100 further comprises a plurality of shipping vehicles 200 which are distributed between the main shipping terminals 102A and the secondary shipping terminals 102B depending on demand. For example, main shipping terminals 102A with a large customer base have more shipping vehicles 200 available than secondary shipping terminals 102B with a smaller customer base. The shipping vehicles 200 are, preferably, designed as a flatbed carrier for holding the items thereon or comprises a housing with, for example, individual compartments to accommodate customers' transportation needs, as will be described in more detail hereinbelow. Preferably, the shipping vehicles 200 are designed to fit onto a deck of the auto carrier and to comply with the load requirements of the auto carrier such as, for example, an autorack railcar 20, auto carrier truck, or a flatbed tow truck.

Each shipping terminal 102A, 102B comprises means 104 for moving the shipping vehicles 200: onto/from a deck of the auto carrier; between the auto carrier and a location for loading/unloading the shipping vehicles 200; and between different auto carriers, for example, between autorack railcars and auto carrier trucks, such as, for example, commercially available tow tractors or Heavy Duty (HD) pickup trucks.

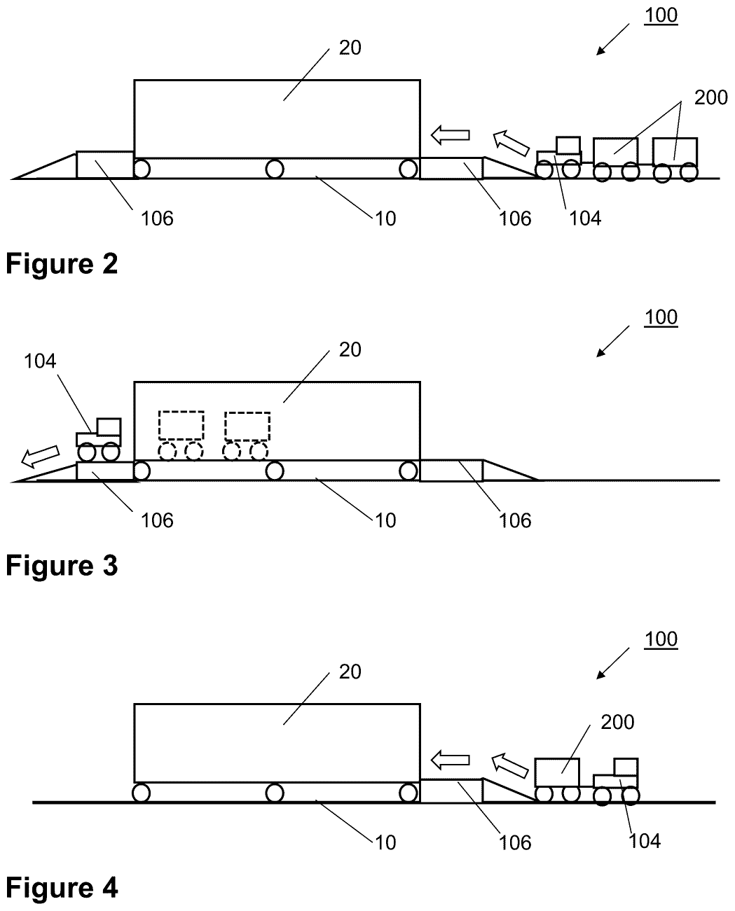

Each main shipping terminal 102A further comprises one or more commercially available ramps 106 which are typically movable and height adjustable to provide an on/off ramp for moving the shipping vehicles 200 onto/from a deck, preferably the lowest deck (A deck), of the autorack rail car 20. For example, use of two ramps 106 enables simultaneous loading of a plurality of shipping vehicles 200 onto the autorack rail car 50 by enabling entering of the autorack rail car 20, with the tow tractor 106 pulling the shipping vehicles 200, at a first end, and enabling the tow tractor 106 to exit the autorack railcar 20 at the second end thereof after being disconnected from the shipping vehicles 200, as illustrated in FIGS. 2 and 3. For unloading, the tow tractor 104 is connected to the shipping vehicles 200 at one of the first and second end of the autorack railcar 20 for pulling the same from the deck of the auto rack rail car 50. Alternatively, one shipping vehicle 200 at a time may be pushed onto the deck of the autorack railcar 20, as illustrated in FIG. 4, with the tow tractor 104 then backing out. After the shipping vehicles 200 are placed onto the deck of the autorack railcar 20 they are individually secured to the deck of the autorack railcar 20, as will be described hereinbelow.

Preferably, each shipping terminal 102A, 102B comprises a protective cover or building that provides easy access of to shipping vehicles 200 for loading and unloading of the same, as well as protection from adverse weather.

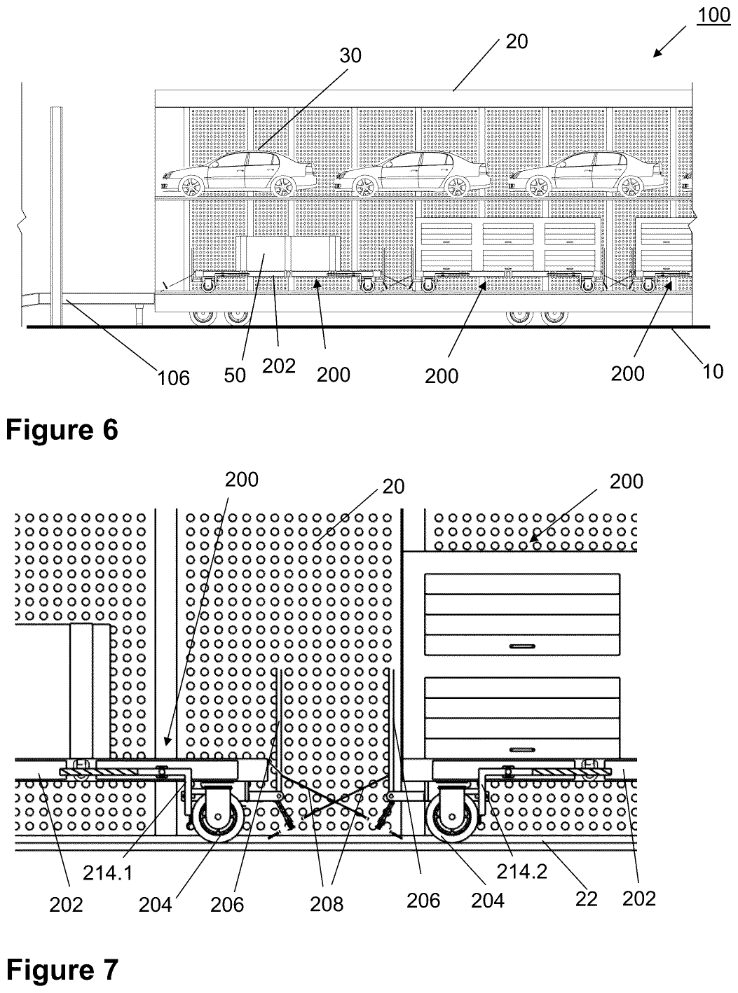

The system 100 enables implementation of a shipping process for shipping smaller batches of items via auto carriers as described in the following example.
A customer calls the operator of the system 100 for information or retrieves information from the operator's website regarding locations of the main terminals 102A and the secondary terminals 102B, routes, pricing, and storage compartment sizes.
The customer then books an individual compartment of a shipping vehicle 200 or the entire shipping vehicle 200 with a drop off date, amount and type of items to be shipped and secures the reservation, for example, with a credit card payment.
   Alternatively, the customer goes directly to one of the shipping terminals and drops off the items.
   Optionally, the customer can add on options for insurance, humidity packs to be disposed inside the compartment(s), high security truck seals and door pickup/delivery. For example, the shipping vehicle 200 is moved to a customer's location via a flatbed tow truck with the shipping vehicle 200 being moved onto/from the deck of the flatbed tow truck using, for example, a winch thereof.
The customer drops off the items and loads them into their reserved individual compartment(s) monitored by an employee. Alternatively, the items may be loaded by the employee after drop off by the customer.
The compartment is then secured in front of the customer with a high security truck seal (if purchased) or another lock which is cut off or unlocked at delivery.
Once the shipping vehicle 200 is loaded, it is removed from the protective cover or building and moved onto a deck of a respective auto carrier using a tow tractor 104 (or HD pickup truck).
When the tow tractor 104 is inside the autorack railcar 20 and the shipping vehicle 20 is in the correct position, the tow tractor 104 is put into ‘park’ while the driver applies the brakes.
Another worker applies the manual brakes 214.1, 214.2 to each set of wheels 204.1, 204.2 on each shipping vehicle 200, as illustrated in FIGS. 6 and 7. This ensures that the shipping vehicles 200 don't move during the load securing process.
Chains or tie-down straps 208 are secured first on the back of the last shipping vehicle 200 and hooked to the correct locations on the deck 22 of the autorack railcar 20.
The front of the last shipping vehicle 200 is then secured with chains or tie-down straps 208. Once it is secure, it is then disconnected from the shipping vehicle 200 or tow tractor 104 in front of it. This process is continued until all shipping vehicles 200 are secured to the deck 22 of the autorack railcar 20.
The remaining space of the autorack railcar 20 is then loaded with passenger vehicles 30, the doors of the autorack railcar 20 are closed and secured and autorack railcar 20 is then released to be railed out.
The customer is supplied with a tracking number and is emailed updates regarding a current location of the shipping vehicle 200.
Once the shipping vehicle 200 arrives at the destination shipping terminal 102A, 102B, the customer is informed about the arrival and has a certain amount of time to pick up the items.
Upon arrival of the autorack railcar 20 the above process is performed in reverse.
Once the shipping vehicle 200 is placed under the protective cover or in the protective building the compartment is unlocked, preferably, in presence of the customer, for removal of the items therefrom.

When the customer drops off items at a secondary shipping terminal 102B the above process comprises the further steps as follows.
The loaded shipping vehicle 200 is moved onto a deck of an auto carrier truck or a flatbed tow truck and secured thereto in a similar manner using chains or tie-down straps.
Using the auto carrier truck or the flatbed tow truck the loaded shipping vehicle 200 is then transported to the nearest main shipping terminal 102A.
At the main shipping terminal 102A the shipping vehicle 200 is un-secured, removed from the auto carrier truck or the flatbed tow truck, moved onto a deck 22 of an autorack railcar 20, and secured to the deck 22 of the autorack railcar 20.

When the destination is a secondary shipping terminal 102B the above process comprises the further steps as follows.
After removal from the autorack railcar 20 the shipping vehicle 200 is moved onto a deck of an auto carrier truck or a flatbed tow truck and secured thereto using chains or tie-down straps.
Using the auto carrier truck or the flatbed tow truck the loaded shipping vehicle 200 is then transported to the destination secondary shipping terminal 102B.
At the destination secondary shipping terminal 102B the shipping vehicle 200 is un-secured, removed from the auto carrier truck or the flatbed tow truck, moved to under the protective cover or into the protective building, and unloaded.

It is noted that for safety reasons in a preferred mode of operation the shipping vehicles 200 are loaded onto the lowest deck (A deck) of the autorack railcar 20. Before securing the shipping vehicles 200 to the deck of the autorack railcar 20 parking brakes are applied. The shipping vehicles 200 are secured at all four corners thereof at 45° angles with tie-down hook placed into a respective bracket or slot. To ensure equal tension on the chains or tie-down straps, chains or tie-down straps at opposite ends of the shipping vehicles 200 are tightened simultaneously. After slack has been removed from the chains or tie-down straps, the ratchet is further tightened 2-3 notches. Furthermore, while moving the shipping vehicles 200 the speed should not exceed 8 kph and only three shipping vehicles 200 should be connected together in a train. To meet loading ramp restrictions the total weight including the tow tractor 104 is limited to a maximum of 10 tons.

For an initial implementation of the system 100 customers have been surveyed to determine their requirements for shipping items across Canada. Out of approximately 2600 surveys it has been found that customers require shipping to and from the three provinces: Alberta (AB), British Columbia (BC), and Ontario (ON) as listed in Table 1.

TABLE 1

| Province | From | To |
|---|---|---|
| AB | 16.1% | 26.5% |
| BC | 20.0% | 24.3% |
| ON | 39.4% | 20.6% |
| Total | 75.5% | 71.4% |

Due to the need for as many as 8 shipping vehicles 200 for each terminal/province, only 3 provinces will be serviced at the initial implementation of the system 100. Demand of how many customers will be shipping items and how many shipping vehicles 200 will be needed is unknown at this time but it can be conservatively estimated based on sending one shipping vehicles 200 once a week from each location. This is believed to be conservative as 74% of customers surveyed have said they are interested in shipping items across Canada, and that equals to about 55% of those surveyed are shipping to/from AB/BC/ON. Based on this information the minimum number of shipping vehicles 200 needed for shipping between these three location is determined as listed in Table 2 below. It is noted that the minimum number of shipping vehicles 200 includes 2 empty shipping vehicles 200 at each location waiting to be loaded.

TABLE 2

| | | Shipping | Shipping | Shipping | |
|---|---|---|---|---|---|
| | | Vehicles | Vehicles | Vehicles | |
| | | 200 in | 200 | 200 that | Shipping |
| | | Transit | waiting | arrived | Vehicles |
| | Transit | during a 7 | to be | and await | 200 |
| Route | Days | day period | loaded | unloading | needed |
| Scarborough | 7 | 1 | 2 | 1 | 4 |
| to Calgary | | | | | |
| Scarborough | 10 | 2 | 2 | 1 | 5 |
| to Delta | | | | | |
| Calgary to | 7 | 1 | 2 | 1 | 4 |
| Scarborough | | | | | |
| Calgary to | 3 | 1 | 2 | 1 | 4 |
| Delta | | | | | |
| Delta to | 10 | 2 | 2 | 1 | 5 |
| Scarborough | | | | | |
| Delta to | 3 | 1 | 2 | 1 | 4 |
| Calgary | | | | | |
| | | | | Total | 26 |

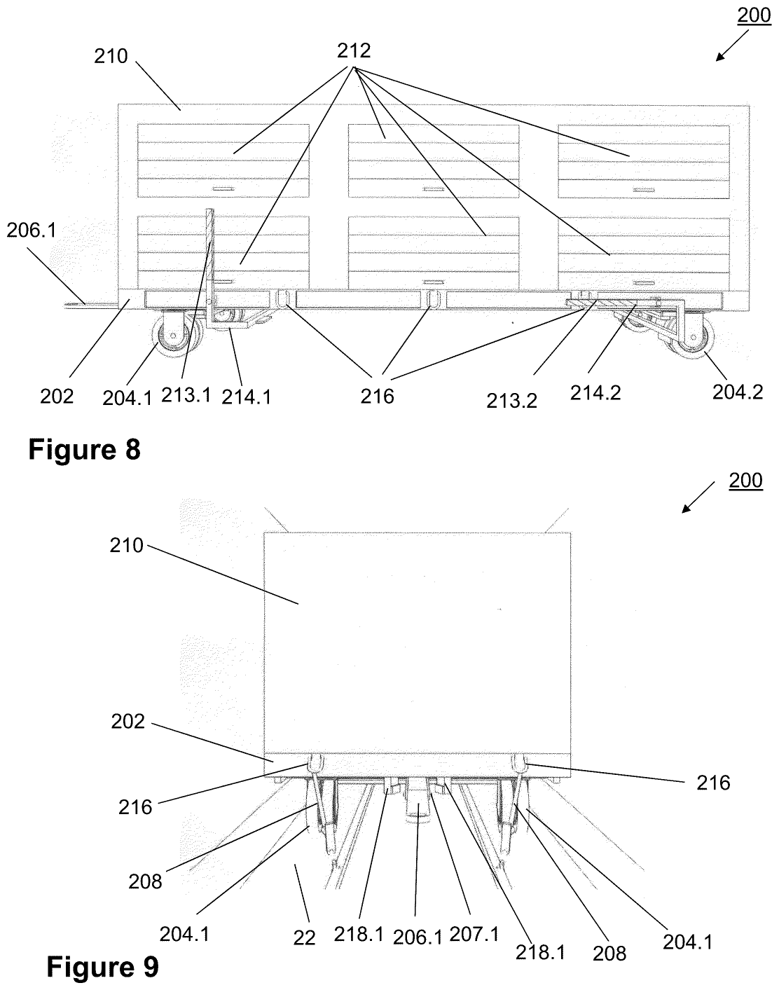

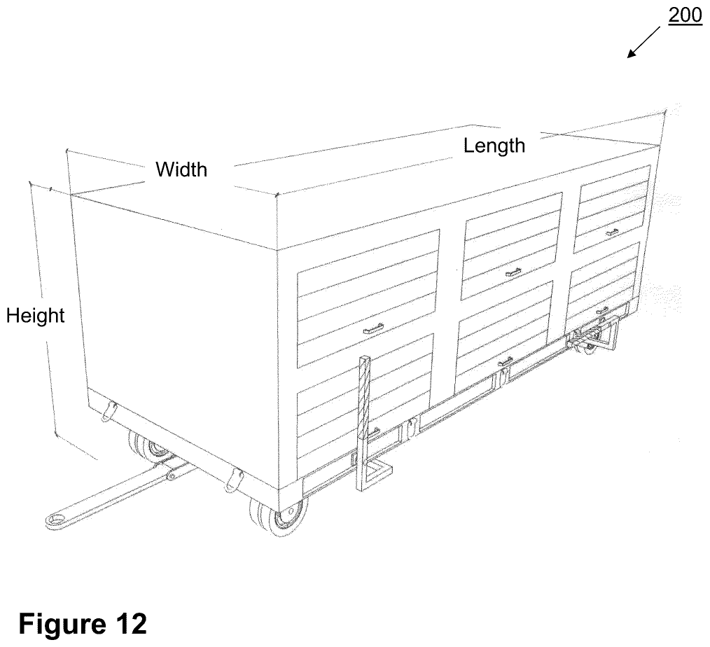

Referring to FIGS. 8 to 12 a shipping vehicle 200 for shipping smaller batches of items via auto carriers according to a preferred embodiment of the invention is provided. The shipping vehicle 200 comprises chassis 202 adapted for holding the items 50 thereon or having an enclosure 210 mounted thereon for holding the items therein. A first set of wheels 204.1 is mounted to the chassis 202 in proximity to a first end thereof and a second set of wheels 204.2 is mounted to the chassis 202 in proximity to a second end thereof. A first steering mechanism is connected to the first set of wheels 204.1 and a second steering mechanism is connected to the second set of wheels 204.2. Preferably, the first set of wheels 204.1 and the second set of wheels 204.2 each comprise two commercially available double wheel heavy duty casters which are connected via respective steering bars 220.1 and 220.2 which in turn are connected to respective drawbars 206.1 and 206.2. Each drawbar 206.1 and 206.2 is pivotally movable mounted to the chassis 202 at respective pivots 222.1 and 222.2, thus enabling steering of the respective casters, as indicated by the block arrows in FIG. 11. Provision of drawbars 206.1, 206.2 at both ends of the shipping vehicle 200 substantially facilitates loading/unloading of the same onto/from a deck of an auto carrier. The drawbars 206.1, 206.2 are provided, for example, as clevis-type or pintle-type drawbars. The wheels may be provided, for example, as pneumatic wheels or solid wheels such as Hamilton® Duralast® wheels. Securing elements 216 such as, for example, D rings, are mounted to the chassis 202 at the first end and the second end for securing the shipping vehicle 200 to a deck 22 of the auto carrier such as, for example, autorack railcar 20. The shipping vehicle 200 is adapted to fit onto a deck 22 of the such as, for example, autorack railcar 20, and to comply with the load requirements thereof, as will be outlined hereinbelow. The chassis 202 is made of, for example, steel, in a conventional manner while the enclosure 210 may be made of a lighter weight material such as, for example, aluminum or composite material, in a conventional manner.

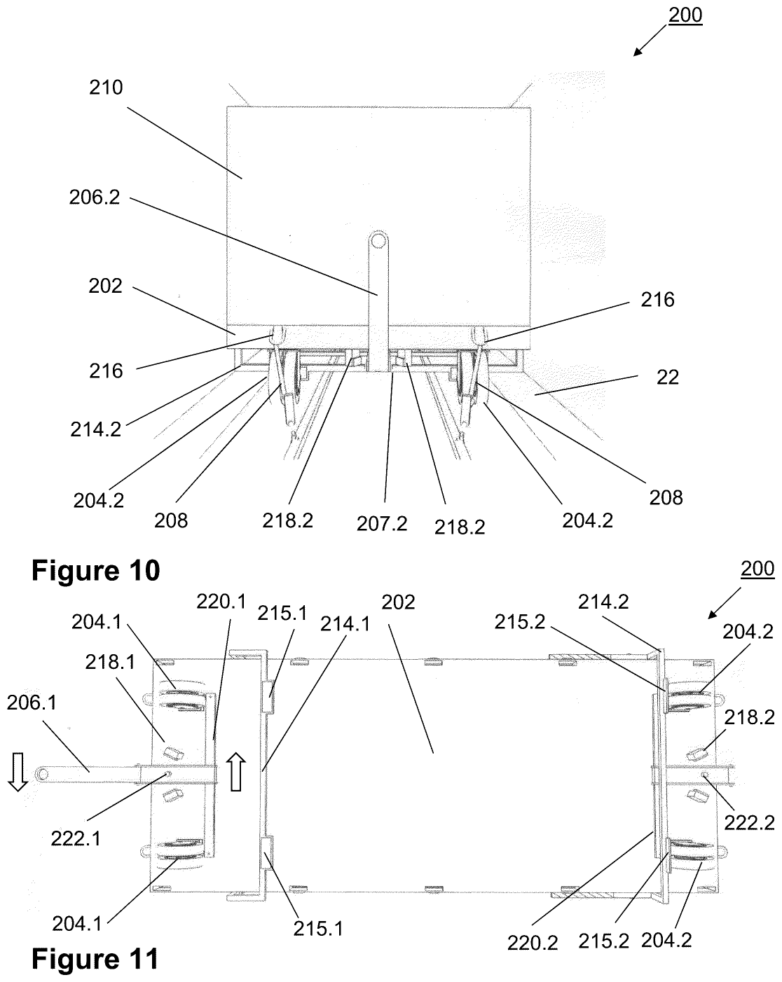

Preferably, the first drawbar 206.1 and the second drawbar 206.2 are pivotally movable, at respective pivots 207.1 and 207.2, between a substantially horizontal position (when in use) and a substantially vertical position (when not use). For example, after the drawbar 206.1 and/or 206.2 is disconnected the same is moved from the horizontal position, as illustrated in FIG. 9, into the vertical position, as illustrated in FIG. 10.

Further preferably, the shipping vehicle 200 further comprises a first parking brake mechanism 214.1 and a second parking brake mechanism 214.2 pivotally movable mounted to the chassis 202 such that braking pads 215.1, 215.2 are disengaged/engaged with the respective set of wheels 204.1, 204.2 when the lever 213.1, 213.2 is in a vertical position or a horizontal position, as illustrated in FIGS. 8 and 11. Optionally, the parking brake mechanisms 214.1, 214.2 comprise a locking mechanism such as, for example, a locking key for securing the same in the disengaged/engaged mode of operation. Alternatively, only one parking brake mechanism for engaging one of the first and second set of wheels 204.1, 204.2 is provided. As is evident to a person of skill in the art, provision of a parking brake mechanism is not limited to the parking brake mechanisms 214.1, 214.2 illustrated in FIGS. 8 and 11, but various other types of parking brakes may be employed dependent on design preferences.

Further preferably, a first steering limiting mechanism 218.1 and a second steering limiting mechanism 218.2 are mounted to the chassis 202 for limiting a steering range of the first set of wheels 204.1 and the second set of wheels 204.2, respectively. The steering limiting mechanisms 218.1 and 218.2 each comprise, for example, two limiting elements mounted on opposite sides of the respective drawbar 206.1 and 206.2 at a predetermined distance thereto. Limiting the steering range prevents the operator of the tow tractor 104 from making too narrow turns that may result in overturning the shipping vehicle 200.

Further preferably, the shipping vehicle 200 comprises a first and a second steering locking mechanism for locking the first set of wheels 204.1 and the second set of wheels 204.2, respectively, in a substantially straight direction when engaged. For example, the locking mechanism comprises a U-shaped element mounted to the chassis 202 which is adapted for accommodating the drawbar 206.1, 206.2 therein when in the vertical position and for securely holding the same via a securing pin accommodated in respective bores disposed in the U-shaped element and the drawbar 206.1, 206.2. Locking the steering, for example, at the first end of the shipping vehicle 200, substantially facilitates maneuvering of the same when the same is pushed via the drawbar 206.2 at the second end.

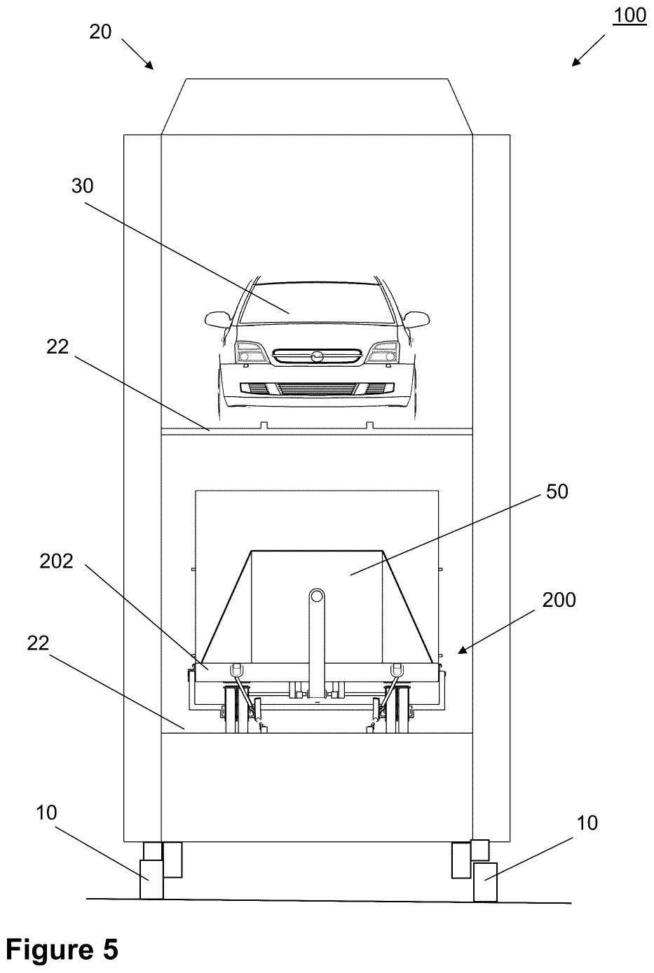

As is evident to a person skilled in the art, the shipping vehicle 200 may be provided in numerous different versions depending on design preferences. For example, the shipping vehicle 200 may be provided as a flatbed version to allow small containers and large and oversized items 50 to be strapped to the chassis 202, as illustrated in FIGS. 5 and 6. Alternatively, a protective enclosure 210 may be mounted to the chassis 202. The enclosure 210 may form a single compartment with one or more doors or comprise a plurality of individual compartments 212 that can be individually locked, as illustrated in FIG. 8. The individual compartments 212 may be provided in different sizes, for example, a small size having 22 cu/ft volume and a large size having 48 cu/ft volume. Further alternatively, the individual compartments 212 may be provided as independent modules that can be placed on the flatbed version and stacked upon each other.

Optionally, inside the compartment 212 small hooks are mounted in proximity to the top of the compartment 212 and small D-rings are mounted to the floor of the compartment 212 for enabling larger items to be tied down inside the compartment 212.

Further optionally, humidity and temperature sensors connected to a processor are disposed inside the compartment 212 for sensing humidity and temperature therein and providing a signal indicative thereof. For example, a warning signal may be sent via wireless communication indicating a fire in the compartment 212 if the sensed temperature is above a predetermined threshold.

Further optionally, at least one of the first set of wheels 204.1 and the second set of wheels 204.2 comprises a slow roll mechanism such as, for example, commercially available slow roll bearings for limiting the speed the shipping vehicle 200 can be moved.

Further optionally, the shipping vehicle 200 comprises an auto steer mechanism for simultaneously steering the first set of wheels 204.1 and the second set of wheels 204.2.

Further optionally, the shipping vehicle 200 comprises laser measuring devices mounted on both ends of the shipping vehicle 200 pointing in opposite directions to both sides of the auto carrier. When each laser detects an equal distance within a predetermined threshold, for example, 6 inches, the shipping vehicle is centered. An indication if the shipping vehicle 200 is centered or not is then provided, for example, as a visual signal or an audible signal.

Further optionally, the shipping vehicle 200 comprises a built in GPS tracking device for enabling tracking of the current location of the shipping vehicle 200.

Further optionally, the shipping vehicle 200 comprises an automatic weight system for sensing the weight added to the shipping vehicle 200.

Further optionally, the chassis 202 of the shipping vehicle 200 comprises opening and two channels going across the width of the cart for engaging a forklift, thus enabling secure lifting and moving of the shipping vehicle 200 using a forklift.

Further optionally, the shipping vehicle 200 comprises a battery powered electric drive mechanism and steering mechanism which is, for example, operated via wireless or wired remote control.

The shipping vehicle 200 is adapted to fit onto a deck of, for example, the autorack railcar 20 and to comply with the load requirements thereof.

The autorack railcar specs and details are:

### Tri-Level Deck

Deck Clearance: A-deck 62⅜ in, B 61⅞ in, C 63⅞ in.
Inside length 89 ft.
Inside width 8 ft 4 in to 9 ft 5⅞ in.
Designed to accept 24,000 lbs allocated by wheel loads as follows: 4 vehicles per deck (1500 lbs maximum load per wheel) 5 vehicles (1200 lbs max load per wheel) 6 vehicles (1,000 lbs max load per wheel) 7 vehicles per (857 lb max load per wheel)
For design purposes, vehicle tread width spacing shall be 60 in and vehicle center of gravity shall be 20 in above the deck and centered laterally on both the automobile and the multi-level rack
A base profile auto is spec as 57 in height, wheel base 125 in, overall length 225 in, ground clearance 5 in, min 4 in ground clearance

### Bi-Level Deck

Deck Clearance: A-deck 87 in, B 93¼ in.
Designed to accept 40,000 lbs allocated by wheel loads as follows: 4 vehicles per deck (2500 lbs maximum load per wheel) 5 vehicles (2000 lbs max load per wheel) 6 vehicles (1667 lbs max load per wheel)
For design purposes, vehicle tread width spacing shall be 76 in and vehicle center of gravity shall be 34 in above the deck and centered laterally on both the automobile and the multi-level rack

### Bridge Plates

Each width is 21½ in

### Chain Tie-Down Track, Chains and Winch

Min working load limit of 3600 lb and min ultimate strength of 11,600 lbs
Adjustment ratchets shall be designed to allow no greater than ¾ in take up per increment of adjustment
5/16 NACM grade 43 chain, standard R hook, ⅚ grab hook (marked with AAR)
Side welded links only.
ASTM A413 5/16 in Class HT

Some example versions of the shipping vehicle 200 are listed below as follows. As is evident to a person skilled in the art these are example implementations and the shipping vehicle 200 is not limited thereto, but may implemented in various different shapes and sizes depending on design preferences.

### Tri Level Railcar Version

58 inches tall
78 inches wide
192 inches long
Wheelbase TBD
Min 6 inches ground clearance
1500 lbs maximum load per wheel.
vehicle tread width spacing shall be 72 max or min of 60 in (middle of tire to middle of tire)
8 storage compartments of equal sizes.
   Swing doors with recessed locking mechanism.
GVWR 10,000

### Bi Level Railcar Version

83 inches tall
78 inches wide
192 inches long.
Wheelbase TBD
Min 6 inches ground clearance
2000 lbs max load per wheel
vehicle tread width spacing shall be 72 in (middle of tire to middle of tire)
12 storage compartments of two different sizes
   Swing doors with recessed locking mechanism.
GVWR 10,000

### Flatbed Version

78 inches wide.
192 inches long
Wheelbase TBD
Min 6 inches ground clearance
2000 lbs max load per wheel.
vehicle tread width spacing shall be 72 in (middle of tire to middle of tire)
D rings for straps approx every two feet on both sides.
Long sides would be flat but the short ends of the car would have a 1 foot steel lip
GVWR 10,000

### Electric Motor Version

78 inches wide
192 inches long
Wheelbase TBD.
Min 6 inches ground clearance
2000 lbs max load per wheel.
vehicle tread width spacing shall be 72 in (middle of tire to middle of tire).
GVWR 10,000
Wired and wireless remote control
Brakes.
Batteries

As described the shipping vehicle 200 is easily adaptable to fit onto a deck of autorack railcars, auto carrier trucks, and flatbed tow trucks and to comply with the load requirements thereof. The shipping vehicle 200 enables easy loading of smaller batches of items, is easily moved onto/from a deck of an autorack railcar, an auto carrier truck, or a flatbed tow truck, and is easily secured to the deck of the autorack railcar, the auto carrier truck, or the flatbed tow truck. Furthermore, the shipping vehicle 200 is simple design, substantially lightweight, and cost effective to manufacture.

The present invention has been described herein with regard to preferred embodiments. However, it will be obvious to persons skilled in the art that a number of variations and modifications can be made without departing from the scope of the invention as described herein.

What is claimed is:

1. A method for shipping items via an auto carrier comprising:
a) loading the items onto or into a shipping vehicle;
b) moving the shipping vehicle onto a deck of an autorack railcar;
c) securing the shipping vehicle to the deck of the autorack railcar;
d) moving the autorack railcar from a first location to a second location;
e) un-securing the shipping vehicle from the deck of the autorack railcar; and,
f) removing the shipping vehicle from the deck of the autorack railcar.

2. The method according to claim 1 comprising:
g) unloading the items from the shipping vehicle.

3. The method according to claim 1 comprising:
g) moving the shipping vehicle onto a deck of an auto carrier truck, or a flatbed tow truck;
h) securing the shipping vehicle to the deck of the auto carrier truck, or the flatbed tow truck;
i) moving the auto carrier truck or the flatbed tow truck from the second location to a third location;
j) un-securing the shipping vehicle from the deck of the auto carrier truck, or the flatbed tow truck;
k) removing the shipping vehicle from the deck of the auto carrier truck, or the flatbed tow truck; and,
l) unloading the items from the shipping vehicle.

4. The method according to claim 1 wherein a) further comprises:
aa) moving the shipping vehicle onto a deck of an auto carrier truck, or a flatbed tow truck;
ab) securing the shipping vehicle to the deck of the auto carrier truck, or the flatbed tow truck;
ac) moving the auto carrier truck or the flatbed tow truck to the first location;
ad) un-securing the shipping vehicle from the deck of the auto carrier truck, or the flatbed tow truck; and,
ae) removing the shipping vehicle from the deck of the auto carrier truck, or the flatbed tow truck.

5. The method according to claim 1 wherein in b) and d) the shipping vehicle is pushed or pulled at a first or second end thereof using a mover connected thereto.

6. The method according to claim 5 wherein a plurality of shipping vehicles is pulled with the shipping vehicles being connected to each other.

7. The method according to claim 1 wherein c) comprises:
engaging manual brakes of the shipping vehicle; and,
tying the shipping vehicle to the deck.

8. The method according to claim 1 further comprising disconnecting a drawbar of the shipping vehicle and moving the same from a substantially horizontal position to a substantially vertical position.

9. A system for shipping items via an auto carrier comprising:
a shipping vehicle for holding the items thereon or therein, the shipping vehicle being adapted to fit onto a deck of the auto carrier and to comply with the load requirements of the auto carrier;
means for moving the shipping vehicle onto/from a deck of the auto carrier; and,
means for securing the shipping vehicle to the deck of the auto carrier.

10. The system according to claim 9 wherein the shipping vehicle is adapted for being pushed or pulled at a first end and a second end thereof.

11. The system according to claim 10 wherein the shipping vehicle is moved using one of a tow tractor, a pick-up truck, or a winch.

12. The system according to claim 9 wherein the shipping vehicle is secured using chains or tie-down straps.

13. The system according to claim 9 wherein the shipping vehicle is adapted for at least one of an autorack railcar, auto carrier truck, and a flatbed tow truck.

14. A shipping vehicle for shipping items via an auto carrier comprising:
a chassis adapted for holding the items thereon or having an enclosure mounted thereon for holding the items therein;
a first set of wheels mounted to the chassis in proximity to a first end thereof and a second set of wheels mounted to the chassis in proximity to a second end thereof;
a first steering mechanism connected to the first set of wheels and a second steering mechanism connected to the second set of wheels; and,
securing elements mounted to the chassis at the first end and the second end for securing the shipping vehicle to a deck of the auto carrier;
wherein the shipping vehicle is adapted to fit onto a deck of the auto carrier and to comply with the load requirements of the auto carrier.

15. The shipping vehicle according to claim 14 wherein the shipping vehicle comprises a first drawbar at a first end and a second drawbar at a second end thereof, the first drawbar and the second drawbar being pivotally movable between a substantially horizontal position and a substantially vertical position.

16. The shipping vehicle according to claim 15 comprising a first and a second steering locking mechanism, the first and the second steering locking mechanism for locking the first set of wheels and the second set of wheels, respectively, in a substantially straight direction when engaged.

17. The shipping vehicle according to claim 15 comprising a first and a second steering limiting mechanism, the first and the second steering limiting mechanism for limiting a steering range of the first set of wheels and the second set of wheels, respectively.

18. The shipping vehicle according to claim 15 wherein each of the first set of wheels and the second set of wheels comprises two casters.

19. The shipping vehicle according to claim 14 wherein the enclosure comprises a plurality of individual compartments that can be individually locked.

20. The shipping vehicle according to claim 14 wherein at least one of the first set of wheels and the second set of wheels comprises a slow roll mechanism.
